(19) United States
(12) Patent Application Publication
(10) Pub. No.: US 2026/0002633 A1
(43) Pub. Date: Jan. 1, 2026

(54) BELLCRANK MOUNTING ASSEMBLIES FOR RAILCARS

(71) Applicant: Gunderson LLC, Lake Oswego, OR (US)

(72) Inventors: Kris Heitmeyer, West Linn, OR (US); Andrew Holst, Vancouver, WA (US)

(73) Assignee: Gunderson LLC, Lake Oswego, OR (US)

(21) Appl. No.: 19/251,213

(22) Filed: Jun. 26, 2025

Related U.S. Application Data
(60) Provisional application No. 63/664,452, filed on Jun. 26, 2024.

(51) Int. Cl. F16M 13/02

(52) U.S. Cl. CPC F16M 13/02

(57) ABSTRACT

Bellcrank mounting assemblies for railcars are disclosed. In some embodiments, the bellcrank mounting assemblies include a bellcrank base attached to an underside of the railcar and a bellcrank mounting bracket removably attached to the bellcrank base. The mounting bracket includes opposed end portions with axially-aligned openings to receive a bellcrank or a sheave wheel.

### CROSS REFERENCE TO RELATED APPLICATIONS

This application claims the benefit of U.S. Provisional Patent Application No. 63/664,452, which was filed on Jun. 26, 2024 and entitled “Bellcrank Mounting Assemblies for Railcars.” The complete disclosure of the above application is hereby incorporated by reference for all purposes.

### BACKGROUND

The present application relates to railroad cars or railcars and, in particular, to bellcrank mounting assemblies for railroad cars.

Railroad cars generally include a bellcrank bracket welded to the railcar body structure to support a bellcrank of a sheave wheel, such as for a handbrake assembly. When the bellcrank bracket needs to be replaced, a torch or grinder would need to be used to remove the bracket. Use of a torch or grinder may, however, burn the paint of the railcar and/or cause a fire, such as to the foam insulation of an insulated boxcar.

What is desired, then, are improved bellcrank mounting assemblies for railroad cars that facilitate removal of the bellcrank bracket without the need for a torch or grinder.

### SUMMARY

Bellcrank mounting assemblies as disclosed herein provide solutions to one or more of the previously mentioned shortcomings of previously known bellcrank mounting assemblies.

In one embodiment, the bellcrank mounting assemblies include a bellcrank base welded to an underside of the railcar and a bellcrank mounting bracket removably attached to the bellcrank base. In one embodiment, the bellcrank base and the bellcrank mounting bracket includes one or more corresponding holes to receive fasteners.

The foregoing and other objectives and features will be more readily understood upon consideration of the following detailed description taken in conjunction with the accompanying drawings.

### BRIEF DESCRIPTION OF THE DRAWINGS

For a better understanding of the invention, and to show how the same may be carried into effect, reference will now be made, by way of example to the accompanying drawings, which:

FIG. 1 shows a partial isometric view of a railcar having a handbrake assembly with a bellcrank and an example of a bellcrank mounting assembly;

FIG. 2 shows a partial rear view of the railcar showing the bellcrank mounting assembly of FIG. 1;

FIG. 3 shows a partial side view of the railcar showing the bellcrank mounting assembly of FIG. 1;

FIG. 4 shows a partial isometric view of the railcar showing the bellcrank mounting assembly of FIG. 1 without a bellcrank pivotably attached;

FIG. 5 shows a side view of the bellcrank mounting assembly of FIG. 4; and

FIG. 6 shows an exploded view of the bellcrank mounting assembly of FIG. 1.

### DETAILED DESCRIPTION

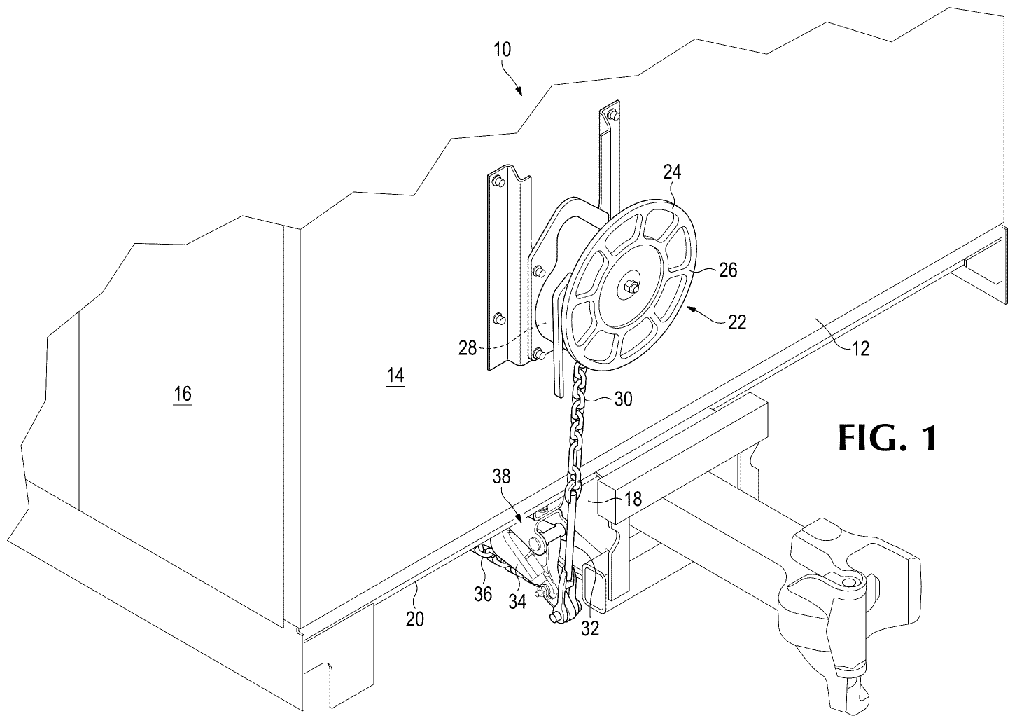

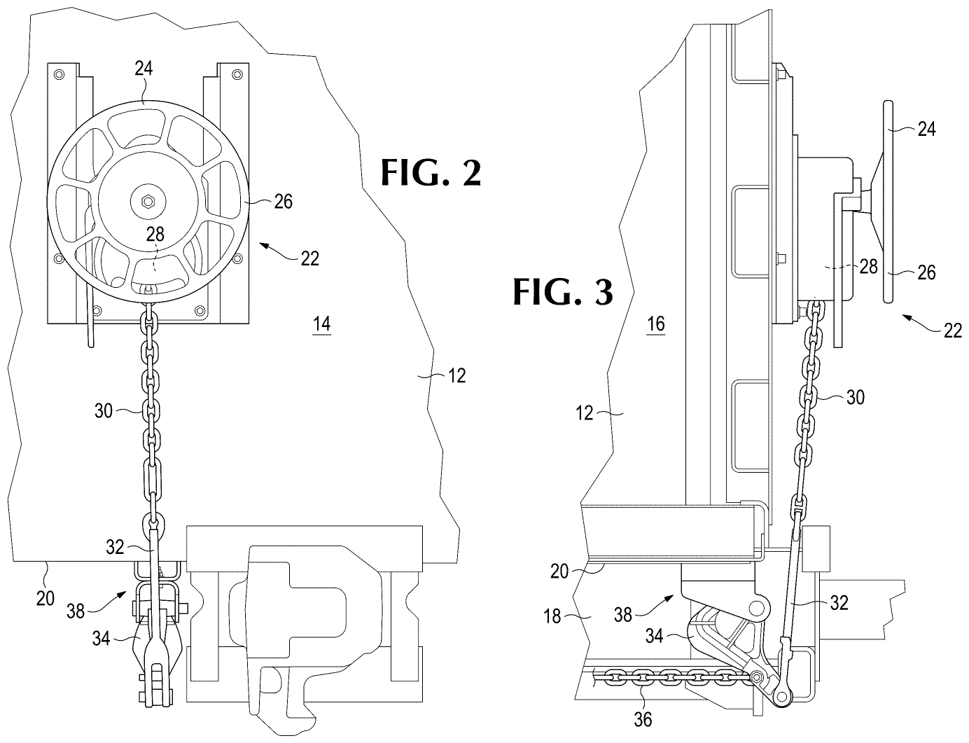

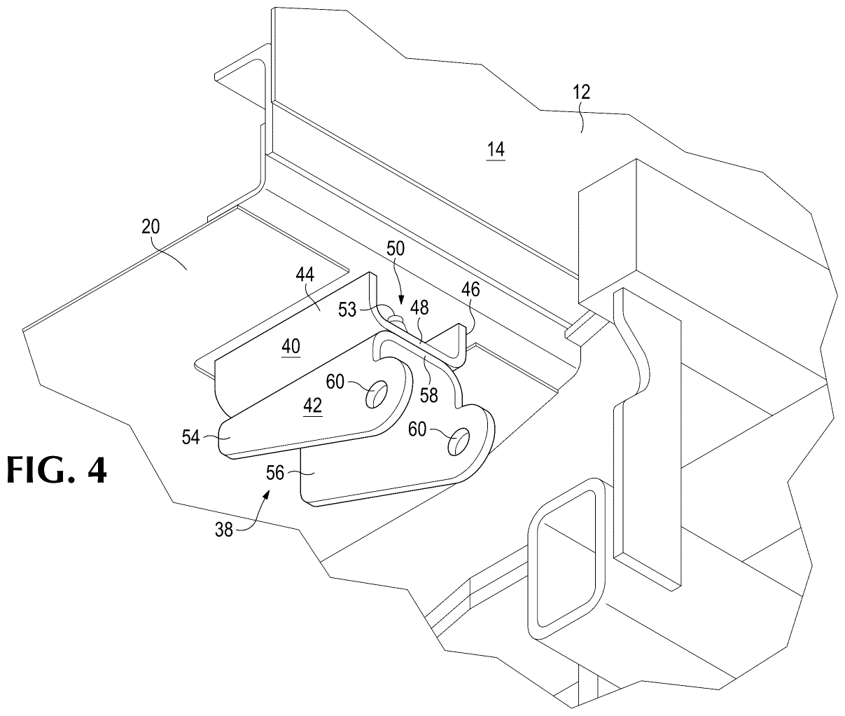

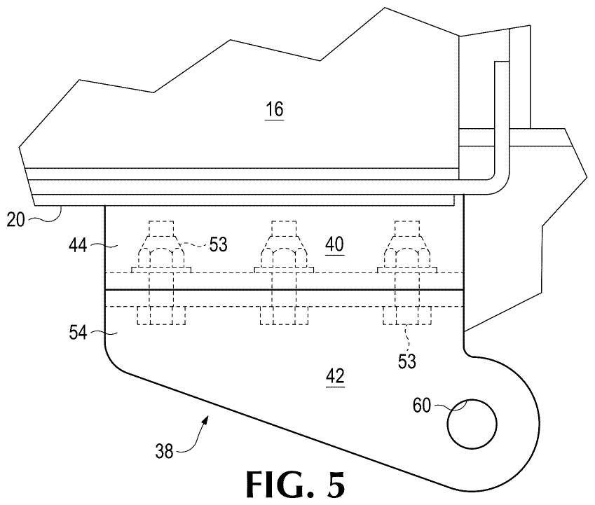

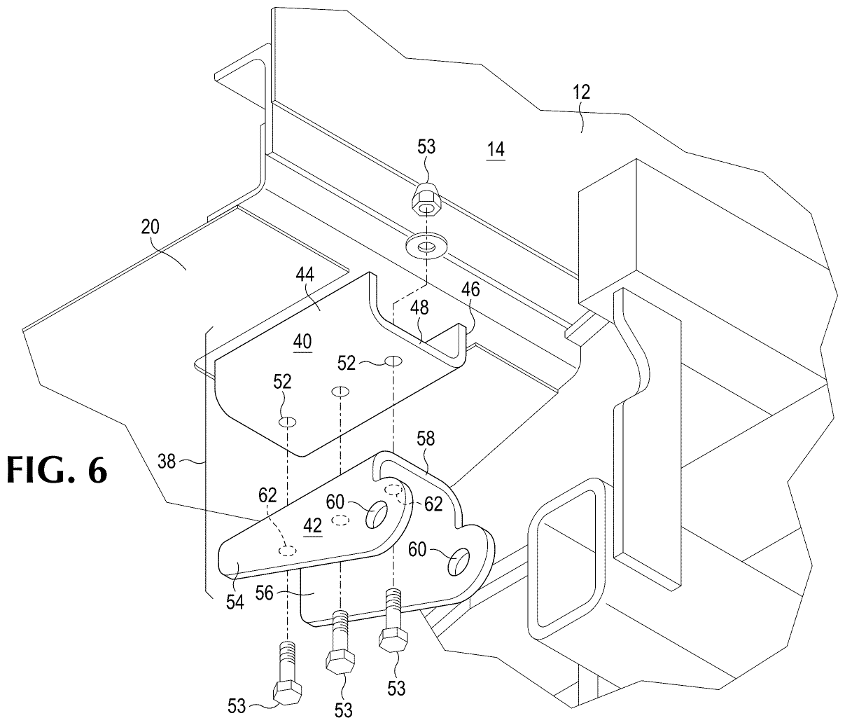

Referring to FIGS. 1-6, a railcar 10 having a railcar body 12 supported on trucks having wheels (not shown). The railcar body includes end walls 14, side walls 16, a longitudinally-extending center sill 18, and an underside 20 (e.g., floor sheet). The railcar body also includes a manually-operated handbrake assembly 22. The handbrake assembly includes a hand-operated handle 24 attached an end wall 14. In the example shown in FIGS. 1-6, the hand-operated handle is in the form of a hand wheel 26 but can take other forms, such as a hand-operated lever. The handle is attached to a gear assembly 28 that provides a mechanical advantage allowing a person to operate the hand wheel. A chain 30 is connected to the gear assembly and to a rod 32, which in turn is connected to one end of a bell crank 34. The other end of bellcrank is connected to the brake rigging (not shown) via, for example, a second chain 36 and a second rod (not shown). The brake rigging moves the brakes (not shown) into and away from the wheels (not shown). An example of a handbrake assembly is shown in U.S. Patent Application Publication No. 2014/0060979, the complete disclosure of which is hereby incorporated by reference for all purposes.

The bellcrank is pivotably attached to the underside of the railcar via a bellcrank mounting assembly 38 to convert the vertical movement of chain 30 on the end of the railcar to horizontal movement underneath the railcar. The bellcrank mounting assembly includes a bellcrank base 40 and a bellcrank mounting bracket or bellcrank pivot frame 42 removably attached to the bellcrank base. The bellcrank base is attached (e.g., welded) to underside 20 adjacent to the end wall with the handbrake assembly. Bellcrank base 40 includes opposed transverse base end portions 44, 46 and a central base portion 48 disposed between those end portions. The transverse base end portions are attached to the underside and the central base portion is spaced away from the underside defining a base access area 50 between the underside and the central base portion and between the base end portions. The base access area allows a user to install and remove fasteners as further discussed below. In the example shown in FIGS. 1-6, bellcrank base 40 is U-shaped. However, other examples of bellcrank base 40 may alternatively, or additionally, include one or more other shapes, such as C-shaped. Bellcrank base 40 includes one or more holes 52 sized to receive fastener(s) 53. In some examples, a brakerod stop (not shown) may be received in and attached to the bellcrank base via one or more of the above fasteners.

Bellcrank mounting bracket 42 includes opposed transverse bracket end portions 54, 56 and a central bracket portion 58. End portions 54 and 56 extend away from the bellcrank base and are spaced from each other. End portions 54 and 56 include axially-aligned openings 60 to receive bellcrank 34 or a sheave wheel (not shown). Central bracket portion 58 includes one or more holes 62 that are sized to receive fastener(s) 53 and that correspond with holes 52 of bellcrank base 40. The central bracket portion is removably attached to central base portion 48 via fasteners 53 (e.g., bolts, nuts, and/or washers) received in corresponding holes 52, 62. In the example shown in FIGS. 1-6, bellcrank mounting bracket is U-shaped. However, other examples of bellcrank mounting bracket 42 may alternatively, or additionally, include one or more other shapes, such as C-shaped.

The bellcrank mounting assemblies shown in FIGS. 1-6 provide for a removable bellcrank mounting bracket. For example, an operator would need to simply loosen and remove fasteners 53 and remove bellcrank mounting bracket 42.

It will be appreciated that the invention is not restricted to the particular embodiment that has been described, and that variations may be made therein without departing from the scope of the invention as defined in the appending claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. A bellcrank mounting assembly for a railcar, comprising:
a bellcrank base attached to an underside of the railcar; and
a bellcrank mounting bracket removably attached to the bellcrank base, the mounting bracket having opposed end portions with axially-aligned openings to receive a bellcrank or a sheave wheel.

2. The assembly of claim 1, wherein the bellcrank base includes opposed first and second end portions that are attached to the underside of the railcar, and a central base portion disposed between the first and second end portions, the central base portion being spaced from the underside.

3. The assembly of claim 2, wherein the bellcrank base is U-shaped.

4. The assembly of claim 2, wherein the central base portion includes at least one hole sized to receive a fastener.

5. The assembly of claim 1, wherein the bellcrank mounting bracket includes opposed third and fourth end portions and a central bracket portion disposed between the third and fourth end portions, each of the third and fourth end portions including one of the axially-aligned openings.

6. The assembly of claim 5, wherein the central bracket portion is removably attached to the bellcrank base and the third and fourth end portions extend away from the bellcrank base.

7. The assembly of claim 6, wherein the bellcrank mounting bracket is U-shaped.

8. The assembly of claim 6, wherein the central bracket portion includes at least one bracket hole to receive a fastener.

9. The assembly of claim 8, wherein the bellcrank base includes at least one base hole that corresponds to the at least one bracket hole.

10. A railcar body having the bellcrank mounting assembly of claim 1.

11. A bellcrank mounting assembly for a railcar, comprising:
a bellcrank base having opposed first and second end portions that are attached to the underside of the railcar, and a central base portion disposed between the first and second end portions, the central base portion being spaced from the underside of the railcar, the central base portion includes one or more base holes to receive a fastener;
a bellcrank mounting bracket having opposed third and fourth end portions and a central bracket portion disposed between the third and fourth end portions, the third and fourth opposed end portions extending away from the bellcrank base and including axially-aligned openings to receive a bellcrank or a sheave wheel, the central bracket portion includes one or more bracket holes that correspond with the one or more base holes; and
a fastener received in at least one of the one or more base holes and at least one of the one or more corresponding bracket holes.

12. The assembly of claim 11, wherein the bellcrank base is U-shaped.

13. The assembly of claim 12, wherein the bellcrank mounting bracket is U-shaped.

14. A railcar body having the bellcrank mounting assembly of claim 11.
